(19) United States
(12) Patent Application Publication
(10) Pub. No.: US 2009/0199496 A1
(43) Pub. Date: Aug. 13, 2009

(54) WINDOW FRAME HEAD AND SILL MEMBERS

(75) Inventors: Ray Garries, Fox Island, WA (US); Gary Brunold, Klamath Falls, OR (US); Chad Elbert, Bonanza, OR (US); Nick Strahm, Klamath Falls, OR (US); Mark Joseph Strong, Klamath Falls, OR (US)

Correspondence Address: NELSON MULLINS RILEY & SCARBOROUGH, LLP, 1320 MAIN STREET, 17TH FLOOR, COLUMBIA, SC, 29201, US

(73) Assignee: JELD-WEN, inc., Klamath Falls, OR (US)

(21) Appl. No.: 12/370,088

(22) Filed: Feb. 12, 2009

Related U.S. Application Data
(60) Provisional application No. 61/028,030, filed on Feb. 12, 2008.

(51) Int. Cl. E06B 1/36; E06B 1/04; B21K 23/00

(52) U.S. Cl. 52/213; 49/504; 29/897

(57) ABSTRACT

A window frame for use with a window assembly with a sash slidably mounted in the window frame, the sash having a top rail, a bottom rail, and a first and a second stile extending therebetween. The window frame includes a head member, a sill member defining a first channel for receiving the bottom rail of the sash when the sash is in a closed position and a trough extending along a bottom of the channel. A pair of jambs extends between opposing ends of the head member and the sill member. The trough is adapted to allow water to pass to a first interior volume of the sill member such that the water is directed to an exterior side of the sill member.

### CLAIM OF PRIORITY

This application claims priority to U.S. Provisional Patent Application Ser. No. 61/028,030, filed Feb. 12, 2008, the entire disclosure of which is hereby incorporated by reference herein.

### FIELD OF THE INVENTION

The present invention relates generally to window assemblies. More particularly, the present invention relates to a frame for a window assembly, having an improved head and sill configuration.

### BACKGROUND

Double-hung window assemblies are commonly used in residential and other structures. Double-hung window assemblies typically include a window frame and a pair of window sashes. The bottom sash may be positioned inwardly of the top sash so that the sashes overlap and can be slid vertically relative to one another along the jambs of the window frame. Window sashes can be made of wood, extruded plastic frame members or metal frame members joined at the corners, for example, to form a generally rectangular frame in which the glazing, or glass panel, is installed.

Double-hung windows often include a locking mechanism located where the sashes meet when the window assembly is in a closed position. A latch mechanism is fixed on the top rail of the bottom sash and the corresponding latch-receiving mechanism may be fixed on the bottom rail of the top sash. When the window sashes are in the closed position, the lock may be engaged to prevent movement of the sashes.

Typically, the latch mechanism fixed on the top rail of the bottom sash projects upwardly therefrom. As such, when the bottom sash is slid upwardly into the fully open position, interference between the latch mechanism and head member of the frame can reduce the area of the opening formed in the window. This reduced area can prove important in that various egress and building codes often exist which require a minimum area for the window opening to facilitate egress therethrough. For a so-called 3050 window, an opening of 5.7 square feet is required. As is commonly known, window sizes are often expressed by the width first and then the height. For example, the aforementioned 3050 window is 3 feet in width and 5 feet in height. A window size that is expressed as a 3644 window is 3 feet, 6 inches in width and 4 feet, 4 inches in height. It would be advantageous to have an improved head member design that allows a window to meet egress and building codes having increased sill member height while improving performance with regard to preventing or reducing water infiltration of the window assembly.

### SUMMARY

The present invention recognizes and addresses considerations of prior art constructions and methods. One embodiment of the present invention discloses a window frame for use with a window assembly comprising a sash slidably mounted in the window frame, the sash comprising a top rail, a bottom rail, and a first and a second stile extending therebetween. The window frame comprises a head member, a sill member defining a first channel for receiving the bottom rail of the sash when the sash is in a closed position and a trough extending along a bottom of the channel. A pair of jambs extends between opposing ends of the head member and the sill member. The trough is adapted to allow water to pass to a first interior volume of the sill member such that the water is directed to an exterior side of the sill member.

Another embodiment of the present invention discloses a window frame for use with a window assembly comprising a sash slidably mounted in the window frame, the sash comprising a top rail, a bottom rail, a first and a second stile extending therebetween, and a lock mechanism disposed on the top rail. The window frame comprises a head member defining a first channel defined by a first inner wall of the head member, a front wall extending downwardly from the first inner wall and a back wall extending downwardly from the first inner wall, a sill member, and a pair of jambs extending between opposing ends of the head member and the sill member. The first channel of the head member is adapted to slidably receive the lock mechanism disposed on the top rail of the sash when the sash is in the fully open position.

Yet another embodiment of the present invention discloses a method of making a window frame for use with a window assembly comprising a sash slidably mounted in the window frame, the sash comprising a top rail, a bottom rail, and a first and a second stile extending therebetween. The method comprises providing a head member, a sill member defining a first channel for receiving the bottom rail of the sash when the sash is in a closed position and a trough extending along a bottom of the channel, and a pair of jambs extending between opposing ends of the head member and the sill member. The trough is adapted to allow water to pass to a first interior volume of the sill member such that the water is directed to an exterior side of the sill member.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1A is a vertical, cross-sectional view of prior art head and sill members;

FIGS. 1B and 1C are vertical, cross-sectional views of a prior art window assembly showing the window assembly in the fully closed and fully open positions, respectively;

FIG. 2 is a partially exploded perspective view of a window assembly including a head member and a sill member in accordance with the present invention;

FIG. 3 is a perspective view of the window assembly as shown in FIG. 3;

FIG. 4A is a vertical, partial cross-sectional view of the window assembly as shown in FIG. 3, showing a head member and a sill member in accordance with the present invention;

FIGS. 4B and 4C are vertical, partial cross-sectional views of the window assembly as shown in FIG. 3, taken along line 4B-4B, showing the window assembly in the fully closed and fully open positions, respectively;

FIG. 5 is a partial top view of the window assembly as shown in FIG. 4C;

FIGS. 6A, 6B and 6C are top, front and side views, respectively, of the sill member as shown in FIG. 3;

FIG. 7 is a vertical, partial cross-sectional view of alternate embodiments of a head member and a sill member in accordance with the present invention; and

FIGS. 8A, 8B and 8C are top, front and side views, respectively, of the alternate embodiment of a sill member as shown in FIG. 7.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

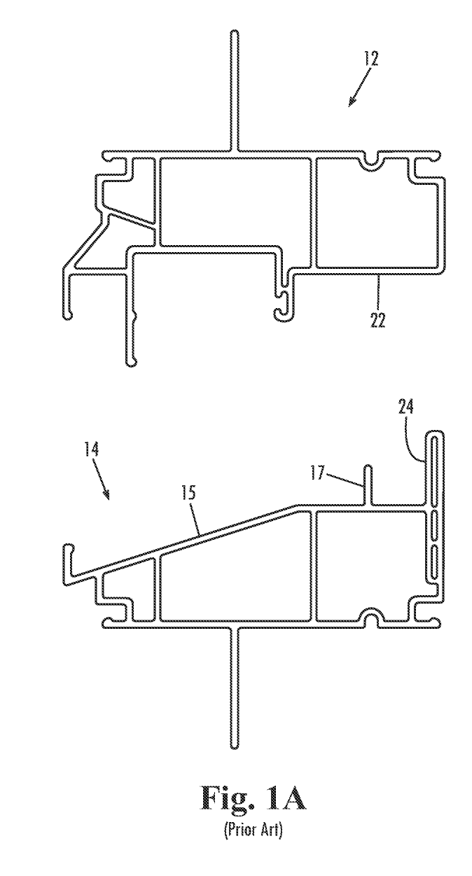

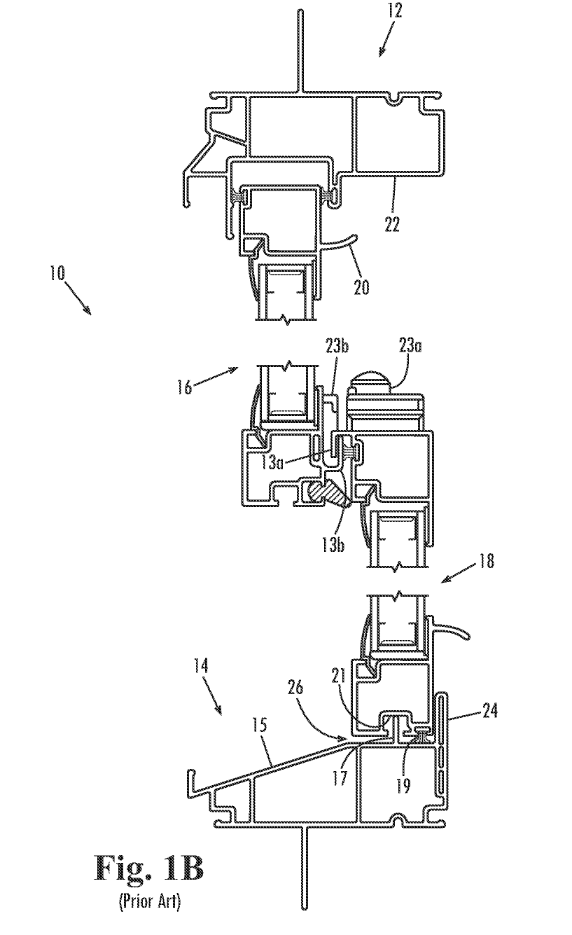

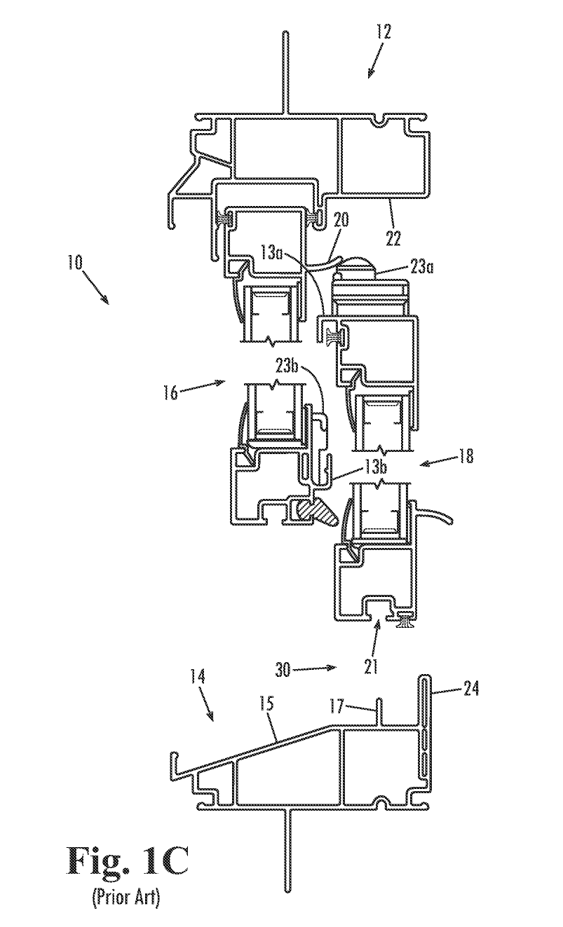

Referring now to FIGS. 1A through 1C, cross-sectional views of a prior art double-hung window assembly 10 are shown. Window assembly 10 includes a frame with a head member 12 and a sill member 14, and a top sash 16 and a bottom sash 18 slidably mounted therein. As shown, a lock assembly latch 23a is disposed on the top rail of bottom sash 18 and a lock assembly receiver 23b is disposed on the bottom rail of top sash 16, and can be used to secure top sash 16 and bottom sash 18 in the closed position. A pair of interlocking lips 13a and 13b are disposed on the top rail of bottom sash 18 and the bottom rail of top sash 16, respectively, and interlock when bottom sash 18 and top sash 16 are secured in the closed position.

As best seen in FIG. 1C, when bottom sash 18 is slid to the open position, lock assembly latch 23a abuts a grasping fin 20 extending outwardly from top sash 16, thereby limiting the sliding motion of bottom sash 18 within the window frame. As such, the area of an opening 30 formed between the bottom rail of bottom sash 18 and the top of sill member 14 is limited in prior art constructions. Moreover, as shown, even if lock assembly latch 23a is slid past grasping fin 20, further upward motion of bottom sash 18 would eventually be prevented when either top wall 22 of head member 12 abuts lock assembly latch 23a, or grasping fin 20 abuts interlocking lip 13a of bottom sash 18.

Prior art sill member 14 limits water intrusion by inhibiting the passage of water between the bottom rail of bottom sash 18 and sill member 14, resulting in the repelled water flowing down along a top surface 15 of sill member 14. To achieve this, typical prior art sill members may include structures such as a vertical fin 17 that extends into a recessed groove 21 formed in the bottom surface of the bottom rail of bottom sash 18. Additionally, weatherstripping 19 is typically provided that extends from the bottom surface of bottom sash 18 such that it contacts an upper surface of sill member 14 when bottom sash 18 is in the closed position.

As best seen in FIG. 1A, tolerance variations between bottom sash 18 and sill member 14 can lead to variations in a gap 26 defined by the these two elements. Moreover, because bottom sash 18 partially supports top sash 16 within the window frame, existing configurations can lead to minor bowing of bottom sash 18, which in turn leads to variations in the gap between bottom sash 18 and sill member 14. As gap 26 varies, weatherstrip 19 that is disposed along the bottom edge of bottom sash 18 can lose contact with the top surface of sill member 14. Additionally, variations in gap 26 can prevent fin 17 from extending fully into recessed groove 21 of bottom sash 18. As such, the ability to prevent water intrusion through gap 26 can be adversely affected. The bowing of various window components noted above can also lead to gaps forming between the bottom rail of bottom sash 18 and interior wall 24 of sill member 14, which also adversely effects the prevention of water infiltration. Also note, if the height of interior wall 24 of sill member 14 is increased in order to increase performance related to preventing water intrusion, opening 30 formed between sill member 14 and bottom sash 18 is further reduced. As such, attempts to increase water intrusion performance of existing sill member designs may lead to limited or reduced window egress area, which may be contrary to certain building codes or other requirements.

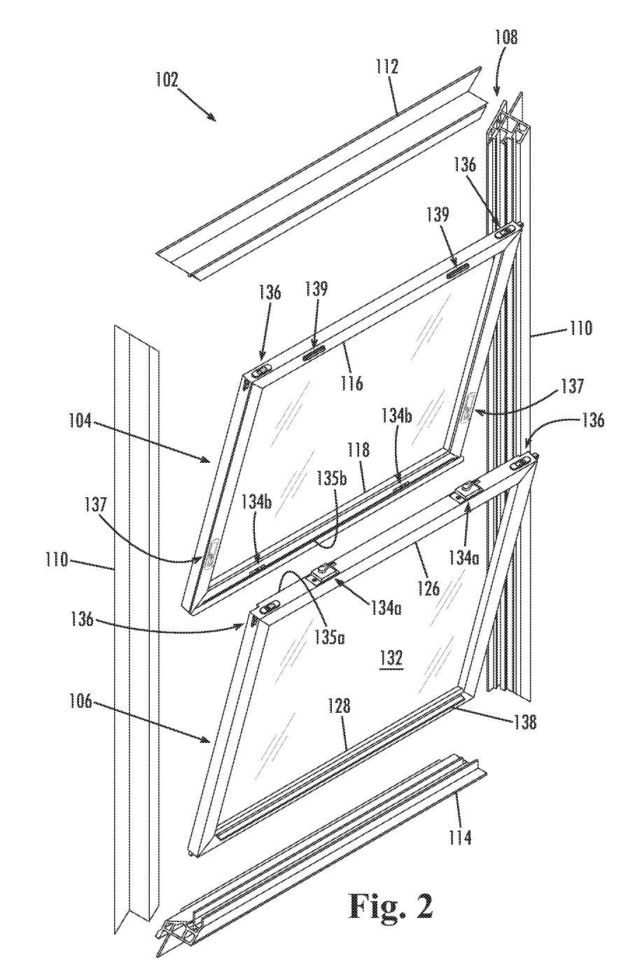

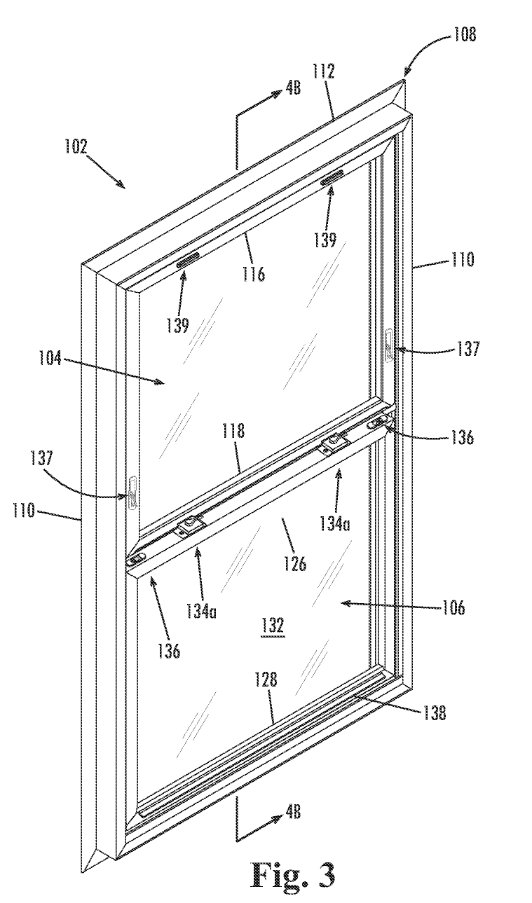

Referring now to FIGS. 2 and 3, a preferred embodiment of a double-hung window assembly 102 including a head member 112 and a sill member 114 in accordance with the present invention is shown. Window assembly 102 includes a top sash 104 and a bottom sash 106 slidably received within frame 108. Frame 108 includes a pair of jambs 110 extending between head member 112 and sill member 114. Bottom sash 106 is positioned inwardly of top sash 104 so that sashes 104 and 106 can be slid vertically relative to each other within frame 108. Lock assembly latches 134a and lock assembly receivers 134b are positioned on a top rail 126 of bottom sash 106 and a bottom rail 118 of top sash 104, respectively, so that movement of sashes 104 and 106 can be prevented when sashes 104 and 106 are in the closed position. As well, a first interlocking lip 135a and a second interlocking lip 135b extend along top rail 126 of bottom sash 106 and a bottom rail 118 of top sash 104, respectively, and interlock when sashes 104 and 106 are in the closed position.

Tilt latches 136 are mounted at the opposite ends of top rails 116 and 126 of each sash. Disengaging tilt latches 136 from jambs 110 of frame 108 allows the respective sash to be tilted outwardly from the frame 108. A lift latch 137 is mounted in each stile of top sash 104 and can be either extended to limit the amount of sliding motion between top and bottom sashes 104 and 106 or retracted to permit full sliding motion. As shown, a grasping fin 138 extends inwardly from bottom rail 128 of bottom sash 106 to facilitate opening and closing bottom sash 106 and a pair of window lift handles 139 extend inwardly from top rail 116 of top sash 104 to facilitate opening and closing top sash 104.

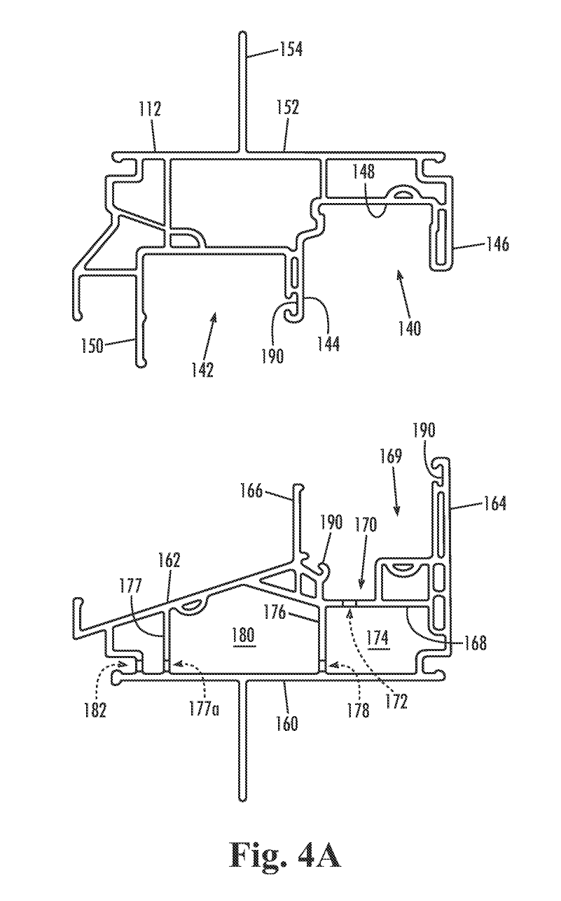

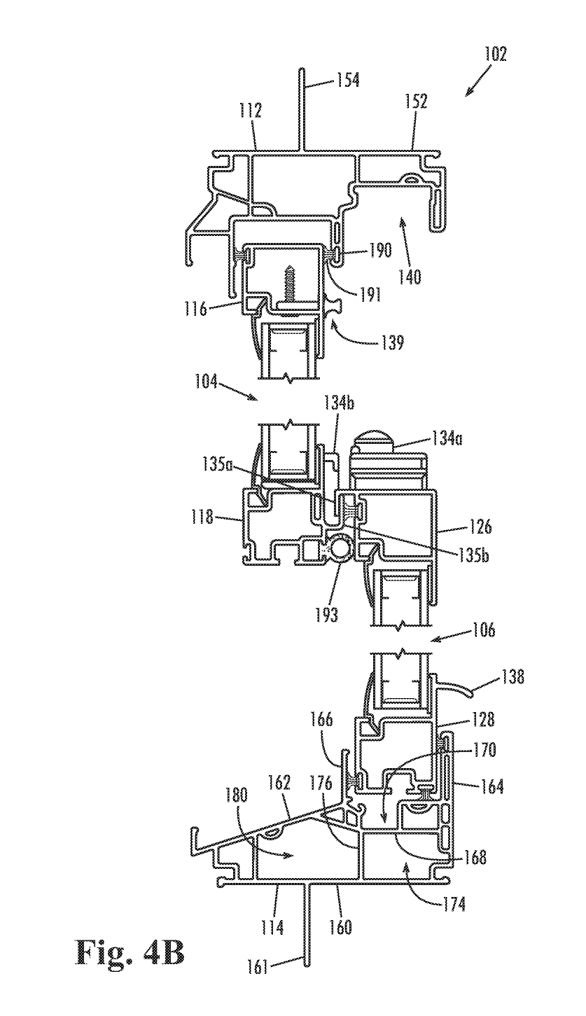

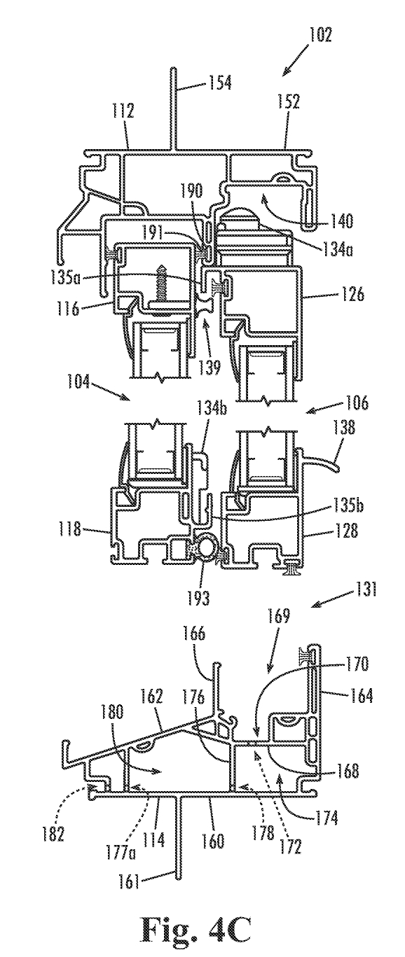

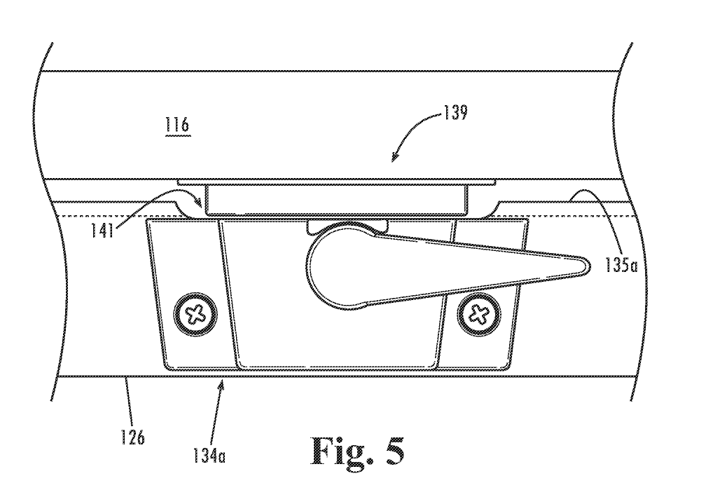

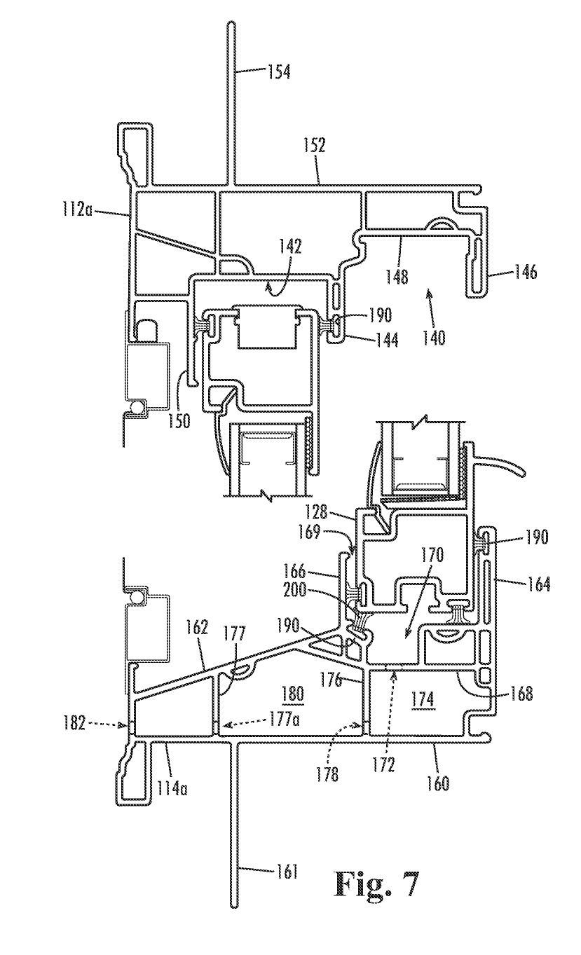

Referring now to FIGS. 4A through 4C and FIG. 7, preferred embodiments of head members 112 and 112a, in accordance with the present invention, are shown. In substantially all material respect, head members 112 and 112a are similarly constructed. Therefore, for ease of description, only head member 112 is discussed. Head member 112 includes an inner channel 140 and an outer channel 142. Inner channel 140 is defined by front wall 144, back wall 146 and an inner wall 148. As best seen in FIG. 4C, inner channel 140 is configured to slidably receive lock assembly latch 134a of bottom sash 106 when bottom sash 106 is placed in the fully open position. Note, as compared to prior art configurations as shown in FIG. 1C, inner channel 140 permits lock assembly latches 134a to extend upwardly into head member 112 such that an opening 131 between bottom sash 106 and sill member 114 is maximized. Outer channel 142 is defined by front wall 144 and exterior wall 150, and is configured to slidably receive top rail 116 of top sash 104. Note, in the preferred embodiment shown, inner channel 140 extends further into head member 112 than does outer channel 142. As best seen in FIG. 5, a notch 141 is formed in interlocking lip 135a of bottom sash 106 adjacent each lock assembly latch 134a such that top rail 126 of bottom sash 106 can be slid past window lift handles 139. Note, however, notches 141 are not required in all embodiments, for example, those that do not include window lift handles in upper sash 106. A nailing fin 154 extends outwardly from top wall 152 for securing window frame 108 (FIGS. 2 and 3) to a building structure (not shown).

As well, head member 112 includes a slot 190 for the positioning of weatherstripping within the head member. As shown, weatherstrip 191 received in slot 190 is fin-type weatherstrip material (such as that available from Amesbury Group (www.amesbury.com)). As well, a bulb-type weatherstrip 193 (also available from Amesbury Group) is received in the bottom rail of top sash 104 for making contact with the top rail of bottom sash 106, when in the closed position. Fin and bulb type weatherstrip materials are preferred for the present embodiment for their ability to limit air, water and particulate infiltration into the window assembly. Other weatherstrip materials and designs may be suitable.

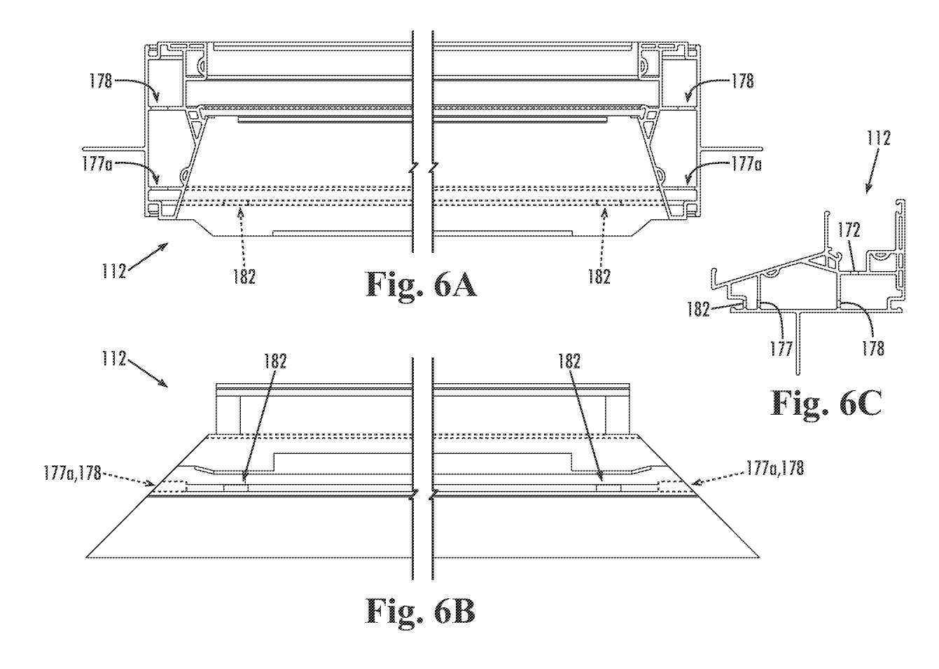

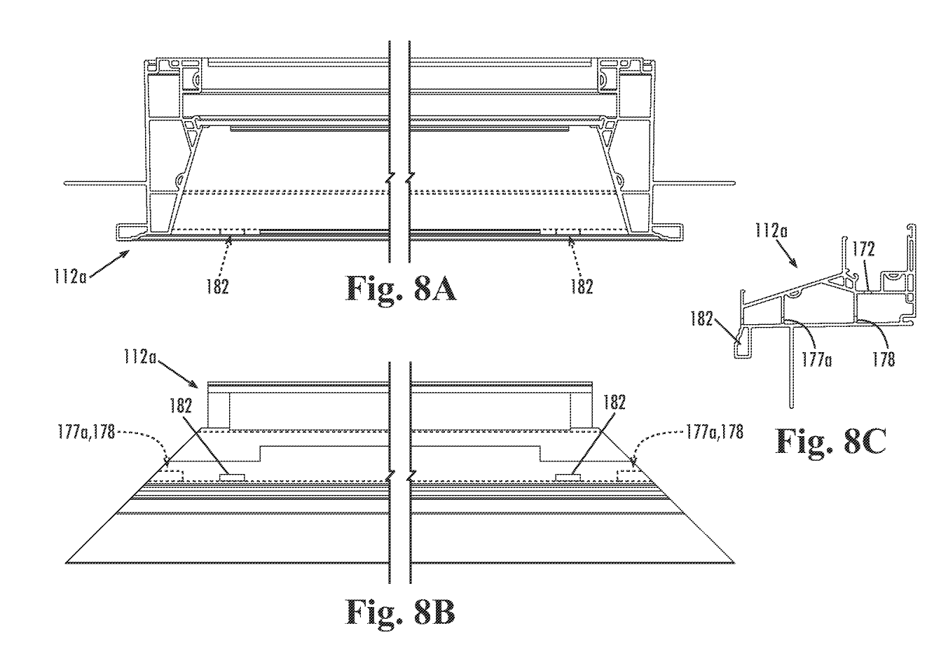

Preferred embodiments of sill members 114 and 114a, in accordance with the present invention, are also shown in FIGS. 4A through 4C and FIG. 7, respectively. In all material respect, sill members 114 and 114a are similarly constructed. As such, for ease of description, only sill member 114 is discussed. Sill member 114 includes a bottom wall 160, a top wall 162, and a channel 169 defined by an interior wall 164, an exterior leg 166 and a floor 168. As best seen in FIG. 4B, channel 169 is configured to slidably receive bottom rail 128 of bottom sash 106. Sill member 114 also defines a first pocket 174 and a second pocket 180 that are divided by partition wall 176. As well, floor 168 of channel 169 further defines a trough 170 that extends the length of channel 169. Trough 170 is disposed above first pocket 174 and is configured such that any water infiltration between exterior leg 166 and bottom rail 128 of bottom sash 106 collects in trough 170 rather than moving to interior wall 164. Sill member 114 defines a number of slots 190 for receiving weatherstripping. As shown, only one slot 190 of sill member 114 includes a weatherstrip therein. Note, however, that in alternate embodiments both slots 190 contain a weatherstip. Top, front and side views of sill member 114 are shown in FIGS. 6A through 6C, respectively, while top, front and side views of sill member 114a are shown in FIGS. 8A through 8C, respectively.

As best seen in FIG. 4B, channel 169 of sill member 114 fully receives bottom rail 128 of bottom sash 106, which is in contrast to prior art sill members 14, such as those shown in FIGS. 1A through 1C. In prior art construction, the exterior portion of the bottom rail is exposed to the elements, which can lead to increased water infiltration. In contrast, water that may happen to pass between bottom rail 128 of bottom sash 106 and exterior leg 166 of sill member 114 collects in trough 170. One or more apertures 172 are defined in floor 168 of trough 170 such that any water that enters trough 170 is allowed to drain into first pocket 174. Similarly, water that enters first pocket 174 eventually passes through apertures 178 formed in partition wall 176 and it enters second pocket 180 of sill member 114, which the water exits by way of apertures 177a formed in second partition wall 177. Ultimately, water passes out of sill member 114 through one or more apertures 182 defined in the front face of sill member 114. Note, apertures 182 are positioned on the exterior side of a nailing fin 161 such that any water passing through apertures 182 is directed away from the exterior of the building structure in which window assembly 102 is mounted.

Note, the disclosed head member 112 and sill member 114 combination allows for increased performance with regard to both preventing water infiltration at increased differential pressures across the window assembly and maximizing the area of an egress opening. More specifically, as best seen in FIG. 4C, the configuration of inner channel 140 allows bottom sash 106 to be more fully opened than in prior art configurations. As such, the dimensions of opening 131 can still be maximized even though the height of interior wall 164 of sill member 114 has been increased to improve performance with regard to preventing water intrusion.

While one or more preferred embodiments of the invention are described above, it should be appreciated by those skilled in the art that various modifications and variations can be made in the present invention without departing from the scope and spirit thereof.

What is claimed:

1. A window frame for use with a window assembly comprising a sash slidably mounted in the window frame, the sash comprising a top rail, a bottom rail, and a first and a second stile extending therebetween, the window frame comprising:
a head member;
a sill member defining a first channel for receiving the bottom rail of the sash when the sash is in a closed position and a trough extending along a bottom of the channel; and
a pair of jambs extending between opposing ends of the head member and the sill member,
wherein the trough is adapted to allow water to pass to a first interior volume of the sill member such that the water is directed to an exterior side of the sill member.

2. The window frame of claim 1, wherein the trough extends along the length of the first channel.

3. The window frame of claim 1, wherein the trough further comprises a floor that defines at least one aperture in fluid communication with the first interior volume of the sill member.

4. The window frame of claim 2, wherein the first interior volume is defined by the floor of the trough and a bottom wall, a rear wall and an interior wall of the sill member.

5. The window frame of claim 4, wherein the interior wall further comprises at least one aperture defined adjacent the bottom wall of the sill member such that the first interior volume is in fluid communication with a second interior volume of the sill member.

6. The window frame of claim 5, further comprising:
a nailing fin extending transversely from an outer surface of the bottom wall of the sill member, the nailing fin having an inner side and an exterior side; and
an aperture defined in a wall of the second interior volume of the sill member such that the water passes out of the sill member on the exterior side of the nailing fin.

7. The window frame of claim 1, wherein the first channel of the sill member further comprises a top surface of the sill member, an interior wall extending upwardly from the top surface of the sill member, and an exterior leg extending upwardly from the top surface of the sill member.

8. The window frame of claim 7, wherein the interior wall of the first channel further comprises a first slot that is parallel to a longitudinal axis of the sill member, and a first weatherstrip disposed in the first slot, wherein the first weatherstrip contacts an inner surface of the bottom rail of the sash when the sash is in the closed position.

9. The window frame of claim 1, the sill member further comprising a second slot that is parallel to a longitudinal axis of the sill member, and a second weatherstrip disposed in the second slot of the sill member such that the second weatherstrip contacts a front surface and a bottom surface of the bottom rail of the sash when the sash is in a closed position.

10. The window frame of claim 1, the head member further comprising a second channel that is adapted to receive the top rail of the sash when the sash is in the fully open position.

11. The window frame of claim 10, wherein the second channel further comprises an inner wall of the head member, a front wall extending downwardly from the inner wall, and a back wall extending downwardly from the inner wall.

12. A window frame for use with a window assembly comprising a sash slidably mounted in the window frame, the sash comprising a top rail, a bottom rail, a first and a second stile extending therebetween, and a lock mechanism disposed on the top rail, the window frame comprising:
a head member defining a first channel defined by a first inner wall of the head member, a front wall extending downwardly from the first inner wall and a back wall extending downwardly from the first inner wall;
a sill member; and
a pair of jambs extending between opposing ends of the head member and the sill member,
wherein the first channel of the head member is adapted to slidably receive the lock mechanism disposed on the top rail of the sash when the sash is in the fully open position.

13. The window frame of claim 12, the head member further comprising a second channel defined by the front wall of the first channel, an exterior wall that is parallel to the front wall, and a second inner wall of the head member that extends transversely between the front wall and the exterior wall, wherein the first channel of the head member extends further into the head member than the second channel.

14. The window frame of claim 13, wherein the head member further comprises a top wall, the first inner wall and the second inner wall are parallel to the top wall, the first inner wall is separated from the top wall by a first distance, the second inner wall is separated from the top wall by a second distance, the second distance being greater than the first distance.

15. The window frame of claim 14, wherein the head member further comprises a nailing fin extending outwardly from an outer surface of the top wall.

16. A method of making a window frame for use with a window assembly comprising a sash slidably mounted in the window frame, the sash comprising a top rail, a bottom rail, and a first and a second stile extending therebetween, the method comprising:
providing a head member;
providing a sill member defining a channel for receiving the bottom rail of the sash when the sash is in a closed position and a trough extending along a bottom of the channel; and
providing a pair of jambs extending between opposing ends of the head member and the sill member,
wherein the trough is adapted to allow water to pass to an interior volume of the sill member such that the water is directed to an exterior side of the sill member.
